(19) United States
(12) Patent Application Publication
(10) Pub. No.: US 2017/0019258 A1
(43) Pub. Date: Jan. 19, 2017

(54) METHODS FOR SECURING AN ACCOUNT-MANAGEMENT APPLICATION AND APPARATUSES USING THE SAME

(71) Applicant: Wistron Corp., New Taipei City (TW)

(72) Inventor: Chih-Chung LIN, New Taipei City (TW)

(21) Appl. No.: 14/937,818

(22) Filed: Nov. 10, 2015

(30) Foreign Application Priority Data
Jul. 15, 2015 (TW) 104122872

(51) Int. Cl. H04L 9/32; G06F 21/78; H04L 9/16; H04L 9/06

(52) U.S. Cl. CPC H04L 9/3236; H04L 9/0643; G06F 21/78; H04L 9/16

(57) ABSTRACT

The invention introduces a method for securing an account-management application, performed by a processing unit, which contains at least the following steps. An executable file of a first type, a first log-in password and a product serial-number are provided. A first encryption-and-hashing algorithm is executed to encrypt and hash the executable file of the first type and the first log-in password by using the product serial-number to generate first cipher-and-hashed data. A second encryption-and-hashing algorithm is executed to encrypt and hash the product serial-number by using the first log-in password to generate second cipher-and-hashed data. The first cipher-and-hashed data, the second cipher-and-hashed data and the product serial-number are stored in a storage device.

### CROSS REFERENCE TO RELATED APPLICATIONS

This Application claims priority of Taiwan Patent Application No. 104122872, filed on Jul. 15, 2015, the entirety of which is incorporated by reference herein.

### BACKGROUND

Technical Field

The present invention relates to the application security, and in particular, to methods for securing an account-management application and apparatuses using the same.

Description of the Related Art

Software tampering means that an attacker modifies an existing application's runtime behavior to perform unauthorized actions. The application code may be exploited by binary patching, code substitution, or code extension. Thus, it is desirable to have methods for securing an account-management application and apparatuses using the same to avoid software tampering.

### BRIEF SUMMARY

The invention introduces a method for securing an account-management application, performed by a processing unit, which contains at least the following steps. An executable file of a first type, a first log-in password and a product serial-number are provided. A first encryption-and-hashing algorithm is executed to encrypt and hash the executable file of the first type and the first log-in password by using the product serial-number to generate first cipher-and-hashed data. A second encryption-and-hashing algorithm is executed to encrypt and hash the product serial-number by using the first log-in password to generate second cipher-and-hashed data. The first cipher-and-hashed data, the second cipher-and-hashed data and the product serial-number are stored in a storage device.

An embodiment of the invention introduces a method for securing an account-management application, executed by a processing unit, which contains at least the following steps. First cipher-and-hashed data associated with an executable file of a first type and a first log-in password, second cipher-and-hashed data and a product serial-number are read from a storage device. A first decryption-and-dehashing algorithm is executed to decrypt and dehash the first cipher-and-hashed data by using the product serial-number to obtain a second log-in password. A first encryption-and-hashing algorithm is executed to encrypt and hash the product-serial number by using the second log-in password to generate third cipher-and-hashed data. It is determined whether the second cipher-and-hashed data matches the third cipher-and-hashed data. If not, the whole process ends.

An embodiment of the invention introduces an apparatus for securing an account-management application, which contains at least a storage device and a processing unit. The processing unit, coupled to the storage device, provides an executable file of a first type, a first log-in password and a product serial-number; executes a first encryption-and-hashing algorithm to encrypt and hash the executable file of the first type and the first log-in password by using the product serial-number to generate first cipher-and-hashed data; executes a second encryption-and-hashing algorithm to encrypt and hash the product serial-number by using the first log-in password to generate second cipher-and-hashed data; and stores the first cipher-and-hashed data, the second cipher-and-hashed data and the product serial-number in the storage device.

An embodiment of the invention introduces an apparatus for securing an account-management application, which contains at least a storage device and a processing unit. The processing unit, coupled to the storage device, reads first cipher-and-hashed data associated with an executable file of a first type and a first log-in password, second cipher-and-hashed data and a product serial-number from the storage device; executes a first decryption-and-dehashing algorithm to decrypt and dehash the first cipher-and-hashed data by using the product serial-number to obtain a second log-in password; executes a first encryption-and-hashing algorithm to encrypt and hash the product-serial number by using the second log-in password to generate third cipher-and-hashed data; determines whether the second cipher-and-hashed data matches the third cipher-and-hashed data; and ends the whole process when the second cipher-and-hashed data does not match the third cipher-and-hashed data.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is a schematic diagram of the network architecture according to an embodiment of the invention;

FIG. 2 is the system architecture of a computer apparatus according to an embodiment of the invention;

FIG. 3 is a flowchart illustrating a method for preparing the secure environment for the executable files of the first type according to an embodiment of the invention;

FIGS. 4A and 4B are schematic diagrams for preparing the secure environment of the executable files of the first type according to an embodiment of the invention;

FIG. 5 is a flowchart illustrating a method for preparing the secure environment for the executable files of the second type according to an embodiment of the invention;

FIGS. 6A and 6B are schematic diagrams for preparing the secure environment of the executable files of the second type according to an embodiment of the invention;

FIGS. 7A and 7B are flowcharts illustrating a method for verifying the executable files according to an embodiment of the invention;

FIGS. 8A to 8C are schematic diagrams for verifying the executable files of the first type according to an embodiment of the invention; and

FIGS. 9A to 9C are schematic diagrams for verifying the executable files of the second type according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

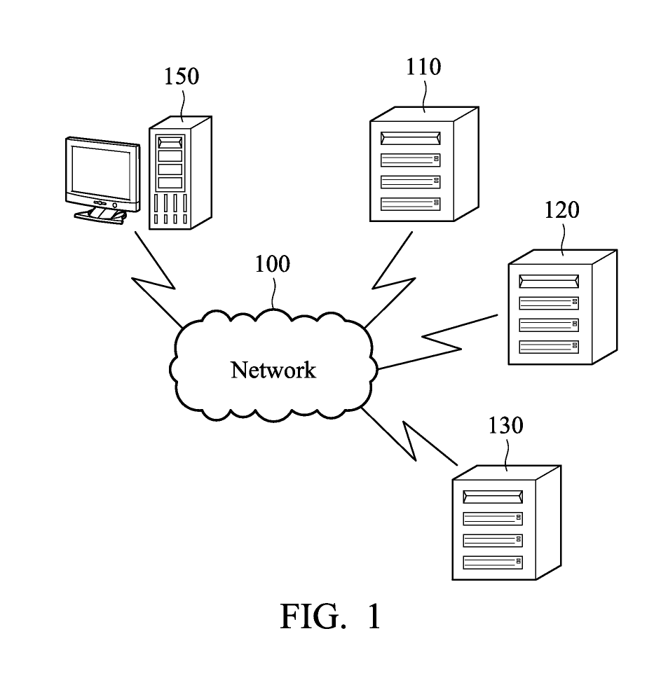

An embodiment of the invention introduces network architecture containing servers provided by different cloud-storage providers and a client for managing pairs of an account and a password for logging in to the servers. FIG. 1 is a schematic diagram of the network architecture according to an embodiment of the invention. Three cloud-storage providers may own the storage servers 110 to 130, such as the google® drive, Dropbox® and SugarSync® servers, respectively. The desktop computer 150 (also referred to as the client) may access data of the storage servers 110 to 130 via the network 100, where the network may be the Internet, a wired LAN (Local Area Network), a WLAN (wireless LAN) or any combination thereof. It should be noted that the client 150 needs to pass the authentication before accessing data of any of the storage servers 110 to 130. Specifically, the client 150 is asked to provide the client ID (Identity) and the password and starts to access data after passing the authentication. The client 150 executes the account-management application to store and modify any of the client IDs and the passwords for logging in to the storage servers 110 to 130 and the user does not have to worry about forgetting the log-in passwords. Although the desktop computer 150 is described in the embodiments as the client, those skilled in the art may implement the functionality in another computer apparatus with a communications capability, such as a mobile phone, a tablet computer, a notebook computer, etc.

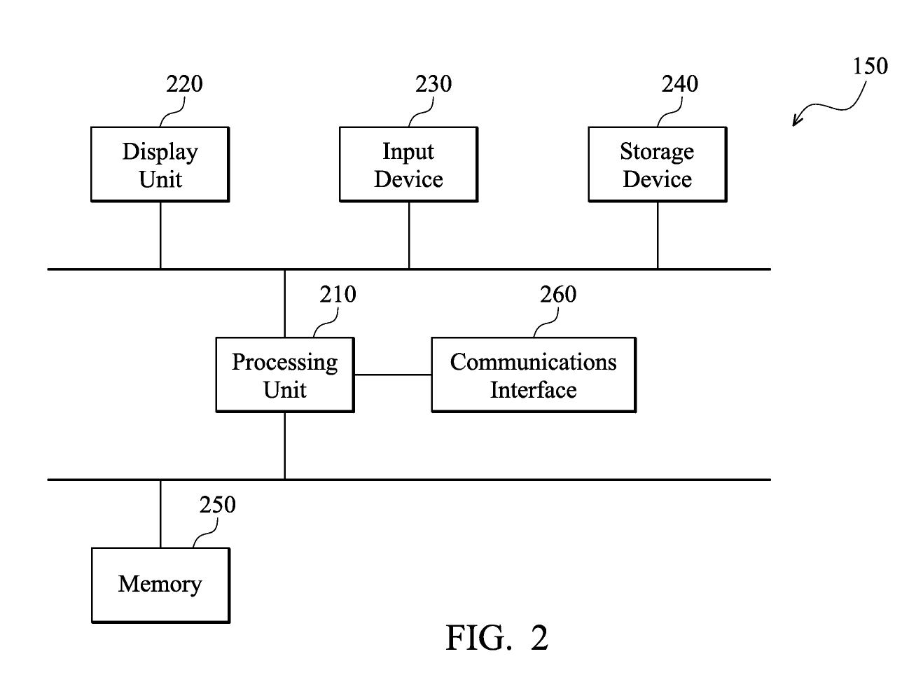

FIG. 2 is the system architecture of a computer apparatus according to an embodiment of the invention. The system architecture may be practiced in the desktop computer, at least including the processing unit 210. The processing unit 210 can be implemented in numerous ways, such as with dedicated hardware, or with general-purpose hardware (e.g., a single processor, multiple processors or graphics processing units capable of parallel computations, or others) that is programmed using codes or software instructions to perform the functions recited herein. The system architecture further includes the memory 250 for storing necessary data in execution, such as variables, data tables, or others, and the storage unit 240 for storing a wide range of electronic files, such as Web pages, documents, video files, audio files, or others. The communications interface 260 is included in the system architecture and the processing unit 210 can thereby communicate with the storage servers 110 to 130 and the other computer apparatuses. The communications interface 260 may be the LAN communications module, the WLAN communications module, the wireless telecommunications module having modems supporting arbitrary combinations of the 2G, 3G, 4G and the higher-generation technology, or any combination thereof. The system architecture further includes one or more input devices 230 to receive user input, such as the keyboard, the mouse, the touch panel, or others. A user may press hard keys on the keyboard to input characters, control the mouse pointer on the display by operating the mouse, or control the executed application with one or more gestures made on the touch panel. The gestures include, but are not limited to, a single-click, a double-click, a single-finger dragging, and a multiple finger dragging. The display unit 220, such as the TFT-LCD (Thin film transistor liquid-crystal display) panel, the OLED (Organic Light-Emitting Diode) panel, or others, may also be included to display input letters, alphanumeric characters and symbols, dragged paths, drawings, or screens provided by an application for a user's viewing.

The storage device 240 stores two types of executable files required by the account-management application. One contains the executable files managing the client ID and the password for logging in to the account-management application. The other contains the executable files managing the client IDs and the passwords for logging in to the cloud servers, such as the storage servers 110 to 130. The executable files of the first type may provide an MMI (Man Machine Interface) to help users to update the client ID and the password for logging in to the account-management application. The executable files of the first type may also provide the functions of storing the client ID and the password. Similarly, the executable files of the second type may provide an MMI to help users to update the client IDs and the passwords for logging in to the cloud servers. The executable files of the second type may also provide functions of storing the client IDs and the passwords for logging in to the cloud servers. To prevent the executable files from being tampered with, the embodiments of the invention introduce the following method to secure the account-management application.

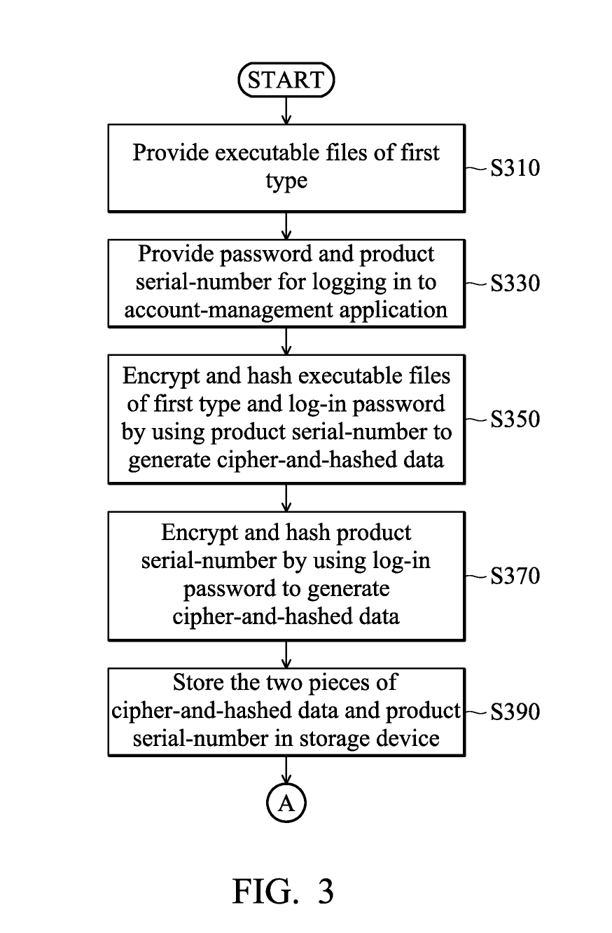

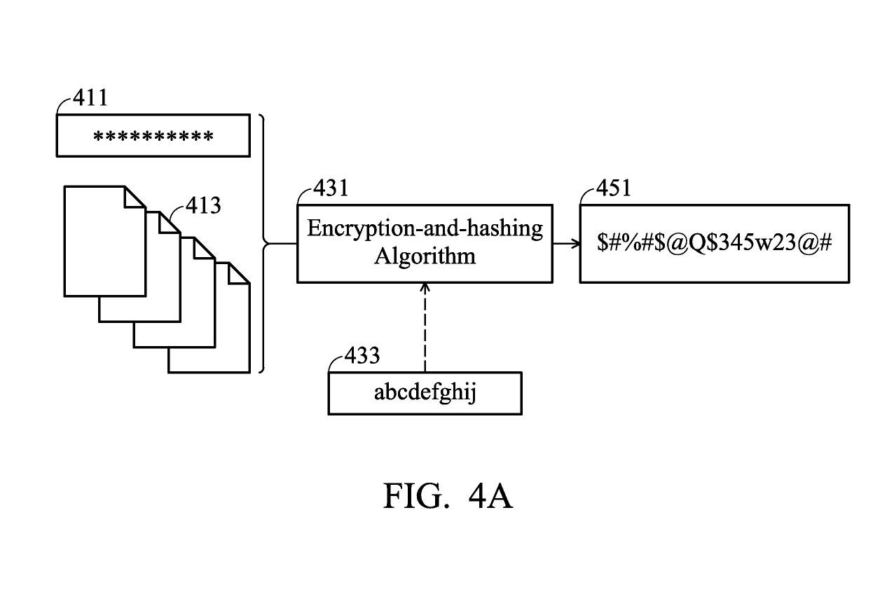

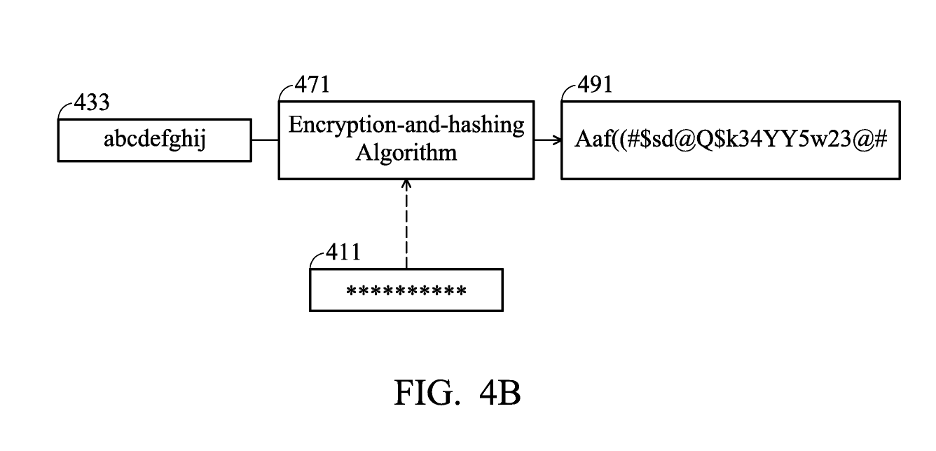

To prevent the executable files of both the first type and the second type from being tampered with, the secure environment has to be prepared before the account-management application is executed for the first time. FIG. 3 is a flowchart illustrating a method for preparing the secure environment for the executable files of the first type according to an embodiment of the invention. The method is performed by the processing unit 210 of the desktop computer 150 when relevant software codes and/or instructions are loaded and executed. FIGS. 4A and 4B are schematic diagrams for preparing the secure environment of the executable files of the first type according to an embodiment of the invention. The process begins with providing the executable files of the first type 413 (step S310). In step S310, the executable files of the first type 413 may be downloaded from the Internet or read from a hard drive, an optical drive, a portable drive, etc. The password 411 for logging in to the account-management application and the product serial-number 433 are provided (step S330). In step S310, the processing unit 210 may provide an MMI to help users to input the password 411 for logging in to the account-management application and the product serial-number 433. The product serial-number 433 is used to identify one and only copy of the account-management application, which is printed on the product package or obtained from the Internet. Refer to FIG. 4A. The encryption-and-hashing algorithm 431 executed by the processing unit 210 generates the cipher-and-hashed data 451 by encrypting and hashing the executable files of the first type 413 and the log-in password 411 using the product serial-number 433 (step S350). The encryption-and-hashing algorithm 471 executed by the processing unit 210 generates the cipher-and-hashed data 491 by encrypting and hashing the product serial-number 433 using the log-in password 411 (step S370). Finally, the cipher-and-hashed data 451, the product serial-number 433 and the cipher-and-hashed data 491 are stored in the storage device 240 (step S390). It should be noted that the log-in password 411 is not stored in the storage device 240 and should be restored by decrypting and dehashing the cipher-and-hashed data 451.

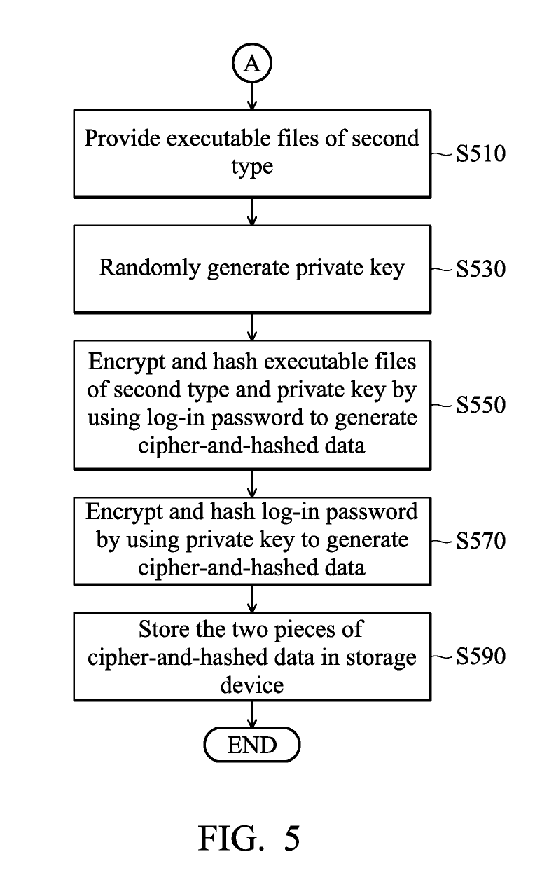

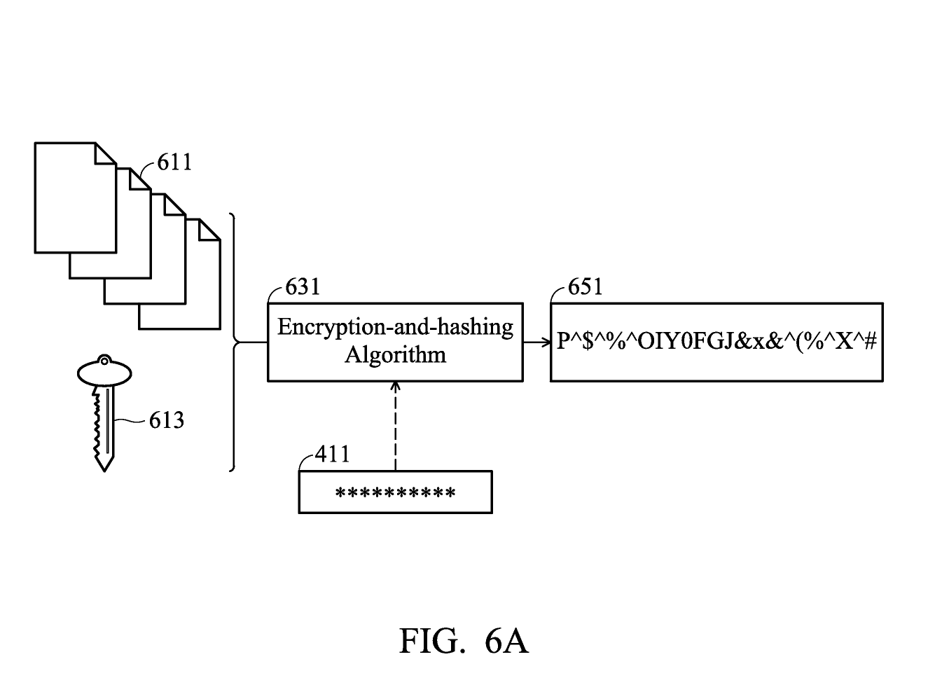

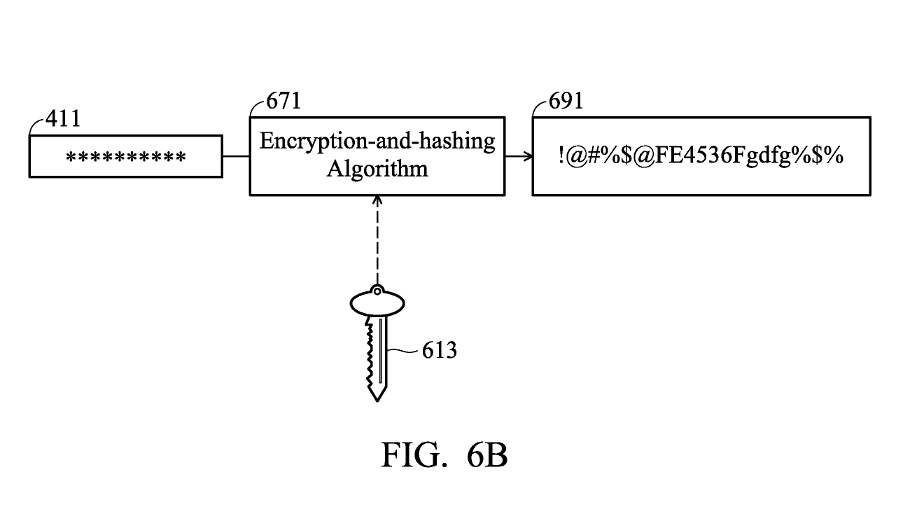

FIG. 5 is a flowchart illustrating a method for preparing the secure environment for the executable files of the second type according to an embodiment of the invention. The method is performed by the processing unit 210 of the desktop computer 150 when relevant software codes and/or instructions are loaded and executed. FIGS. 6A and 6B are schematic diagrams for preparing the secure environment of the executable files of the second type according to an embodiment of the invention. The process begins with providing the executable files of the second type 611 (step S510). In step S510, the executable files of the second type 611 may be downloaded from the Internet or read from a hard drive, an optical drive, a portable drive, etc. The executable files of the second type 611 are used as an input source to generate a private key 613 randomly (step S530). The encryption-and-hashing algorithm 631 executed by the processing unit 210 generates the cipher-and-hashed data 651 by encrypting and hashing the executable files of the second type 611 and the private key 613 using the log-in password 411 (step S550). The encryption-and-hashing algorithm 671 executed by the processing unit 210 generates the cipher-and-hashed data 691 by encrypting and hashing the log-in password 411 using the private key 613 (step S570). Finally, the cipher-and-hashed data 651 and the cipher-and-hashed data 691 are stored in the storage device 240 (step S590). It should be noted that the log-in password 411 is not stored in the storage device 240. The aforementioned encryption-and-hashing algorithm may include a encryption algorithm and a hashing algorithm. In some embodiments, data is encrypted by the encryption algorithm, and then, the encrypted data is hashed by the hashing algorithm to generate the cipher-and-hashed data. In some embodiments, data is hashed by the hashing algorithm, and then, the hashed data is encrypted by the encryption algorithm to generate the cipher-and-hashed data.

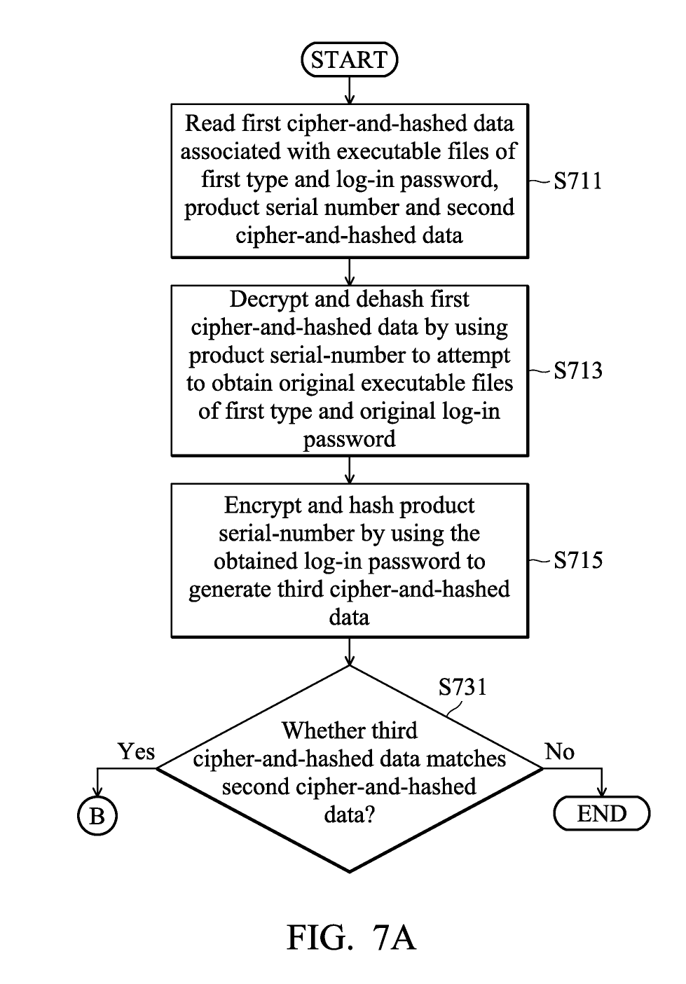

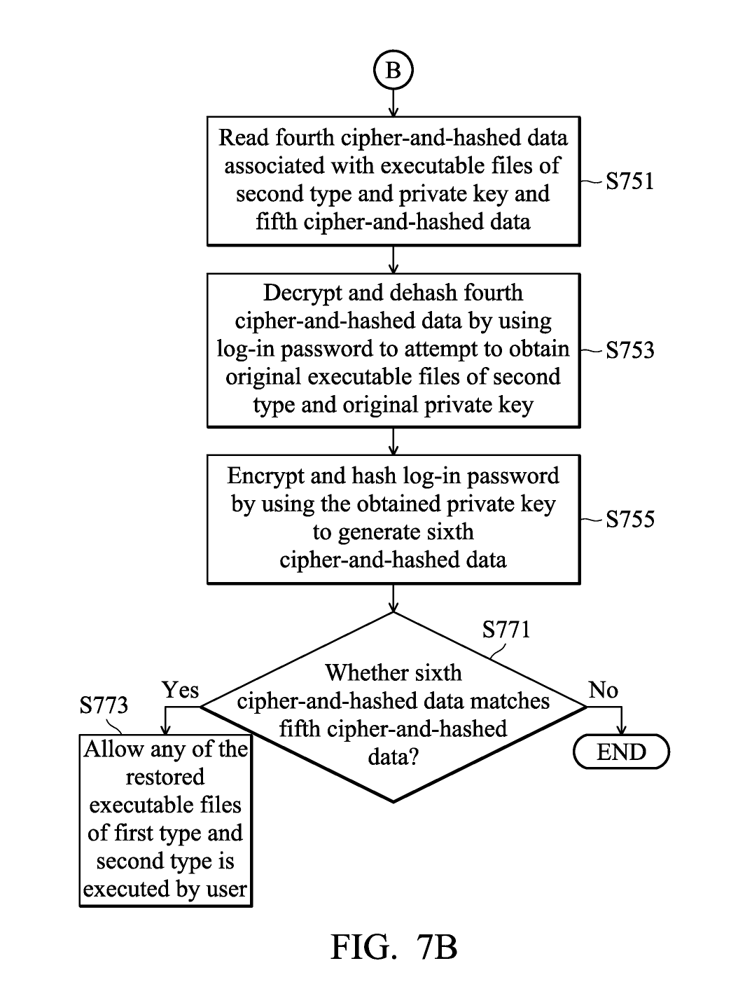

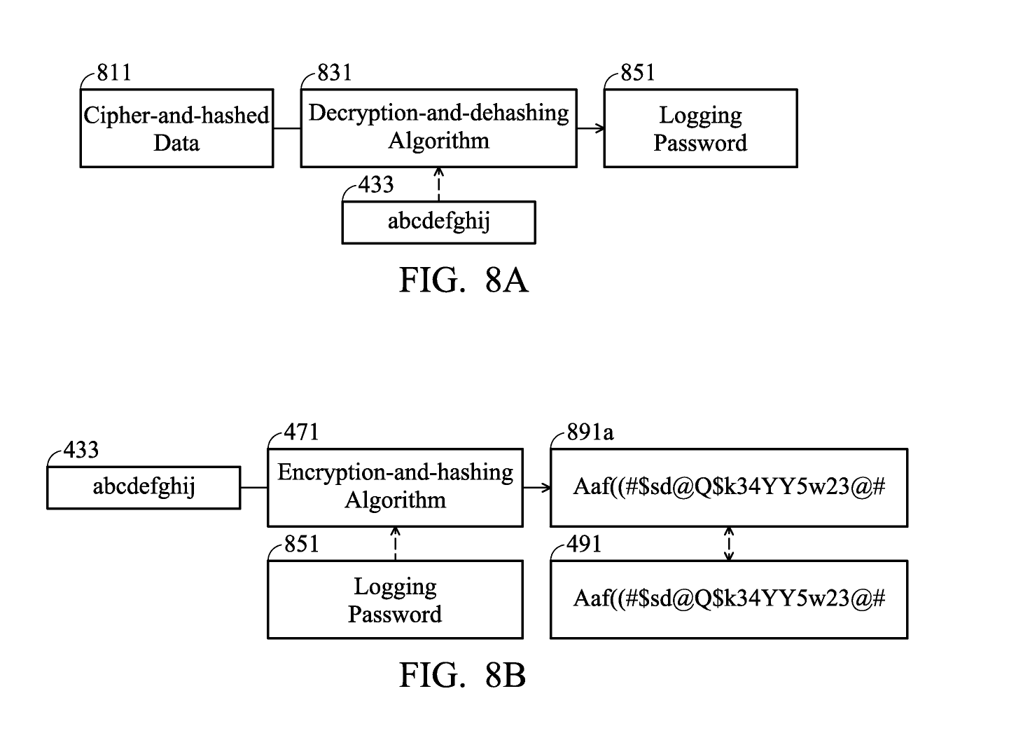

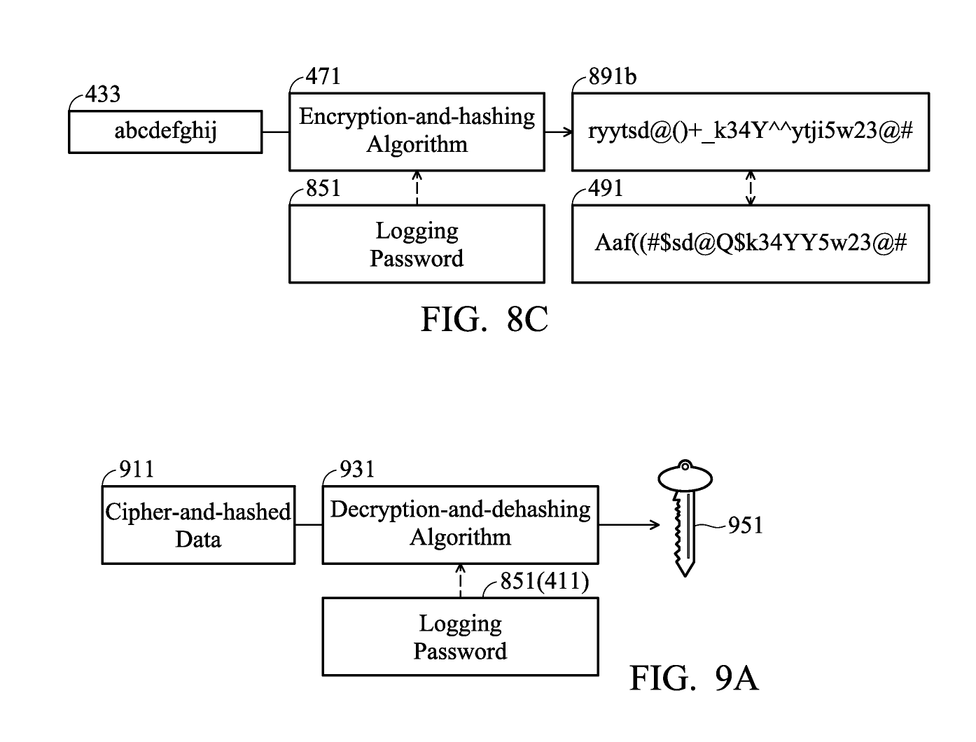

Each time before any executable file of the account-management application is executed, it should be ensured that the executable files of the first type and the second type have not been tampered with. FIGS. 7A and 7B are flowcharts illustrating a method for verifying the executable files according to an embodiment of the invention. FIGS. 8A to 8C are schematic diagrams for verifying the executable files of the first type according to an embodiment of the invention. The processing unit 210 reads the cipher-and-hashed data 811, the product serial-number 433 and the cipher-and-hashed data 491 associated with the executable files of the first type 413 and the log-in password 411 from the storage device 240 (step S711). Refer to FIG. 8A. The decryption-and-dehashing algorithm 831 executed by the processing unit 210 decrypts and dehashes the cipher-and-hashed data 811 by using the product serial-number 433 to obtain the executable files of the first type and the log-in password 851 (step S713). It should be noted that the decryption-and-dehashing algorithm 831 contains the reverse procedures of the encryption-and-hashing algorithm 431 and attempts to restore the executable files of the first type 413 and the log-in password 411. The encryption-and-hashing algorithm 471 executed by the processing unit 210 encrypts and hashes the product serial-number 433 by using the obtained password 851 to generate the cipher-and-hashed data 891 (step S715). Next, it is determined whether the cipher-and-hashed data 891 generated in step S715 matches the cipher-and-hashed data 491 (step S731). If so, the executable files of the first type and the log-in password enclosed in the cipher-and-hashed data 811 have not been tampered with. Refer to FIG. 8B. The generated cipher-and-hashed data 891a matches the cipher-and-hashed data 491. If not, the executable files of the first type and/or the log-in password enclosed in the cipher-and-hashed data 811 have been tampered with and the whole process ends so as to prevent the executable files of the first type restored in step S713 from being executed. Refer to FIG. 8C. The generated cipher-and-hashed data 891b does not match the cipher-and-hashed data 491.

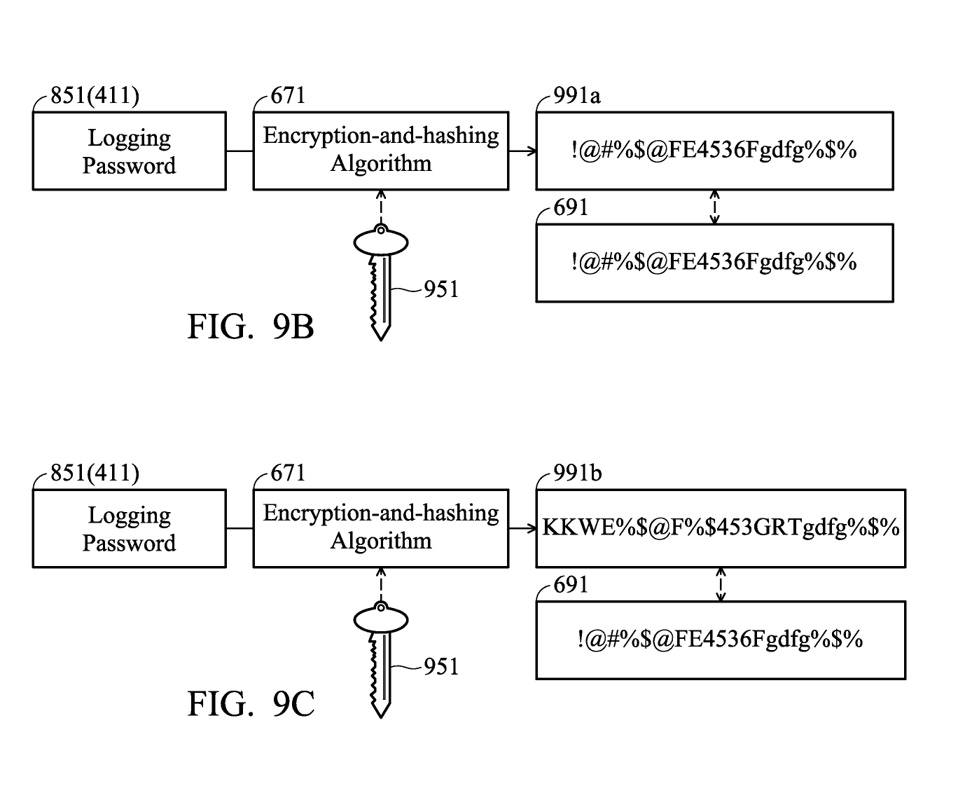

FIGS. 9A to 9C are schematic diagrams for verifying the executable files of the second type according to an embodiment of the invention. The processing unit 210 reads the cipher-and-hashed data 911 and the cipher-and-hashed data 691 associated with the executable files of the second type 611 and the randomly generated private key 613 from the storage device 240 (step S751). Refer to FIG. 9A. The decryption-and-dehashing algorithm 931 executed by the processing unit 210 decrypts and dehashes the cipher-and-hashed data 911 by using the verified password 851 to obtain the executable files of the second type and the private key 951 (step S753). It should be noted that the decryption-and-dehashing algorithm 931 contains the reverse procedures of the encryption-and-hashing algorithm 631 and attempts to restore the executable files of the second type 611 and the private key 613. The encryption-and-hashing algorithm 671 executed by the processing unit 210 encrypts and hashes the verified password 851 by using the obtained private key 951 to generate the cipher-and-hashed data 991 (step S755). Next, it is determined whether the cipher-and-hashed data 991 generated in step S755 matches the cipher-and-hashed data 691 (step S771). If so, the executable files of the second type and the private key enclosed in the cipher-and-hashed data 911 have not been tampered with. Refer to FIG. 9B. The generated cipher-and-hashed data 991a matches the cipher-and-hashed data 691. If not, the executable files of the second type and/or the private key enclosed in the cipher-and-hashed data 911 have been tampered with and the whole process ends, in order to prevent the executable files of the second type restored in step 5753 from being executed. Refer to FIG. 9C. The generated cipher-and-hashed data 99 lb does not match the cipher-and-hashed data 691. When the executable files of the second type and the private key have not been tampered with (“Yes” path of step S771), any of the executable files of the first type and the second type is allowed to execute by a user (step S773).

Although the embodiment has been described as having specific elements in FIG. 2, it is noted that additional elements may be included to achieve better performance without departing from the spirit of the invention. While the process flows described in FIGS. 3, 5, 7A and 7B each includes a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for securing an account-management application, performed by a processing unit, comprising:
providing an executable file of a first type, a first log-in password and a product serial-number;
executing a first encryption-and-hashing algorithm to encrypt and hash the executable file of the first type and the first log-in password by using the product serial-number to generate first cipher-and-hashed data;
executing a second encryption-and-hashing algorithm to encrypt and hash the product serial-number by using the first log-in password to generate second cipher-and-hashed data; and
storing the first cipher-and-hashed data, the second cipher-and-hashed data and the product serial-number in a storage device.

2. The method of claim 1, further comprising:
reading third cipher-and-hashed data associated with the executable file of the first type and the first log-in password, the second cipher-and-hashed data and the product serial-number from the storage device;
executing a first decryption-and-dehashing algorithm to decrypt and dehash the third cipher-and-hashed data by using the product serial-number to obtain a second log-in password;
executing the second encryption-and-hashing algorithm to encrypt and hash the product-serial number by using the second log-in password to generate fourth cipher-and-hashed data;
determining whether the second cipher-and-hashed data matches the fourth cipher-and-hashed data; and
ending the whole process when the second cipher-and-hashed data does not match the fourth cipher-and-hashed data.

3. The method of claim 2, wherein the executable file of the first type provides a first MMI (Man Machine Interface) to facilitate an update of a client ID (IDentity) and a password for logging in to an account-management application.

4. The method of claim 1, further comprising:
providing an executable file of a second type;
randomly generating a first private key;
executing a third encryption-and-hashing algorithm to encrypt and hash the executable file of the second type and the first private key by using the log-in password to generate third cipher-and-hashed data;
executing a fourth encryption-and-hashing algorithm to encrypt and hash the first log-in password by using the first private key to generate fourth cipher-and-hashed data; and
storing the third cipher-and-hashed data and the fourth cipher-and-hashed data in the storage device.

5. The method of claim 4, further comprising:
reading fifth cipher-and-hashed data associated with the executable file of the first type and the first log-in password, the second cipher-and-hashed data and the product serial-number from the storage device;
executing a first decryption-and-dehashing algorithm to decrypt and dehash the fifth cipher-and-hashed data to obtain a second log-in password;
executing the second encryption-and-hashing algorithm to encrypt and hash the product-serial number by using the second log-in password to generate sixth cipher-and-hashed data;
determining whether the second cipher-and-hashed data matches the sixth cipher-and-hashed data; and
ending the whole process when the second cipher-and-hashed data does not match the sixth cipher-and-hashed data.

6. The method of claim 5, further comprising:
when the second cipher-and-hashed data matches the sixth cipher-and-hashed data, reading seventh cipher-and-hashed data associated with the executable file of the second type and the first private key and the fourth cipher-and-hashed data from the storage device;
executing a second decryption-and-dehashing algorithm to decrypt and dehash the seventh cipher-and-hashed data by using the second log-in password to obtain a second private key;
executing the fourth encryption-and-hashing algorithm to encrypt and hash the second log-in password by using the second private key to generate eighth cipher-and-hashed data;
determining whether the fourth cipher-and-hashed data matches the eighth cipher-and-hashed data; and
ending the whole process when the fourth cipher-and-hashed data does not match the eighth cipher-and-hashed data.

7. The method of claim 6, further comprising:
allowing execution of the executable files of the first type enclosed in the first cipher-and-hashed data and the executable file of the second type enclosed in the third cipher-and-hashed data when the fourth cipher-and-hashed data matches the eighth cipher-and-hashed data.

8. A method for securing an account-management application, executed by a processing unit, comprising:
reading first cipher-and-hashed data associated with an executable file of a first type and a first log-in password, second cipher-and-hashed data and a product serial-number from a storage device;
executing a first decryption-and-dehashing algorithm to decrypt and dehash the first cipher-and-hashed data by using the product serial-number to obtain a second log-in password;
executing a first encryption-and-hashing algorithm to encrypt and hash the product-serial number by using the second log-in password to generate third cipher-and-hashed data;
determining whether the second cipher-and-hashed data matches the third cipher-and-hashed data; and
ending the whole process when the second cipher-and-hashed data does not match the third cipher-and-hashed data.

9. The method of claim 8, further comprising:
when the second cipher-and-hashed data matches the third cipher-and-hashed data, reading fourth cipher-and-hashed data associated with an executable file of a second type and a first private key and fifth cipher-and-hashed data from the storage device;
executing a second decryption-and-dehashing algorithm to decrypt and dehash the fourth cipher-and-hashed data by using the second log-in password to obtain a second private key;
executing a second encryption-and-hashing algorithm to encrypt and hash the second log-in password by using the second private key to generate sixth cipher-and-hashed data;
determining whether the fifth cipher-and-hashed data matches the sixth cipher-and-hashed data; and
ending the whole process when the fifth cipher-and-hashed data does not match the sixth cipher-and-hashed data.

10. The method of claim 9, further comprising:
allowing execution of the executable file of the first type enclosed in the first cipher-and-hashed data and the executable file of the second type enclosed in the fourth cipher-and-hashed data when the fifth cipher-and-hashed data matches the sixth cipher-and-hashed data.

11. An apparatus for securing an account-management application, comprising:
a storage device; and
a processing unit, coupled to the storage device, providing an executable file of a first type, a first log-in password and a product serial-number;
executing a first encryption-and-hashing algorithm to encrypt and hash the executable file of the first type and the first log-in password by using the product serial-number to generate first cipher-and-hashed data; executing a second encryption-and-hashing algorithm to encrypt and hash the product serial-number by using the first log-in password to generate second cipher-and-hashed data; and storing the first cipher-and-hashed data, the second cipher-and-hashed data and the product serial-number in the storage device.

12. The apparatus of claim 11, wherein the processing unit reads third cipher-and-hashed data associated with the executable file of the first type and the first log-in password, the second cipher-and-hashed data and the product serial-number from the storage device; executes a first decryption-and-dehashing algorithm to decrypt and dehash the third cipher-and-hashed data by using the product serial-number to obtain a second log-in password; executes the second encryption-and-hashing algorithm to encrypt and hash the product-serial number by using the second log-in password to generate fourth cipher-and-hashed data; determines whether the second cipher-and-hashed data matches the fourth cipher-and-hashed data; and ends the whole process when the second cipher-and-hashed data does not match the fourth cipher-and-hashed data.

13. The apparatus of claim 12, wherein the executable file of the first type provides a first MMI (Man Machine Interface) to facilitate an update of a client ID (IDentity) and a password for logging in to an account-management application.

14. The apparatus of claim 11, wherein the processing unit provides an executable file of a second type; randomly generates a first private key; executes a third encryption-and-hashing algorithm to encrypt and hash the executable file of the second type and the first private key by using the log-in password to generate a third cipher-and-hashed data; executes a fourth encryption-and-hashing algorithm to encrypt and hash the first log-in password by using the first private key to generate a fourth cipher-and-hashed data; and stores the third cipher-and-hashed data and the fourth cipher-and-hashed data in the storage device.

15. The apparatus of claim 14, wherein the processing unit reads fifth cipher-and-hashed data associated with the executable file of the first type and the first log-in password, the second cipher-and-hashed data and the product serial-number from the storage device; executes a first decryption-and-dehashing algorithm to decrypt and dehash the fifth cipher-and-hashed data to obtain a second log-in password; executes the second encryption-and-hashing algorithm to encrypt and hash the product-serial number by using the second log-in password to generate sixth cipher-and-hashed data; determines whether the second cipher-and-hashed data matches the sixth cipher-and-hashed data; and ends the whole process when the second cipher-and-hashed data does not match the sixth cipher-and-hashed data.

16. The apparatus of claim 15, wherein the processing unit, when the second cipher-and-hashed data matches the sixth cipher-and-hashed data, reads seventh cipher-and-hashed data associated with the executable file of the second type and the first private key and the fourth cipher-and-hashed data from the storage device; executes a second decryption-and-dehashing algorithm to decrypt and dehash the seventh cipher-and-hashed data by using the second log-in password to obtain a second private key; executes the fourth encryption-and-hashing algorithm to encrypt and hash the second log-in password by using the second private key to generate eighth cipher-and-hashed data; determines whether the fourth cipher-and-hashed data matches the eighth cipher-and-hashed data; and ends the whole process when the fourth cipher-and-hashed data does not match the eighth cipher-and-hashed data.

17. The apparatus of claim 16, wherein the processing unit allows execution of the executable file of the first type enclosed in the first cipher-and-hashed data and the executable file of the second type enclosed in the third cipher-and-hashed data when the fourth cipher-and-hashed data matches the eighth cipher-and-hashed data.

18. An apparatus for securing an account-management application, comprising:
a storage device; and
a processing unit, coupled to the storage device, reading first cipher-and-hashed data associated with an executable file of a first type and a first log-in password, second cipher-and-hashed data and a product serial-number from the storage device; executing a first decryption-and-dehashing algorithm to decrypt and dehash the first cipher-and-hashed data by using the product serial-number to obtain a second log-in password; executing a first encryption-and-hashing algorithm to encrypt and hash the product-serial number by using the second log-in password to generate third cipher-and-hashed data; determining whether the second cipher-and-hashed data matches the third cipher-and-hashed data; and ending the whole process when the second cipher-and-hashed data does not match the third cipher-and-hashed data.

19. The apparatus of claim 18, wherein the processing unit, when the second cipher-and-hashed data matches the third cipher-and-hashed data, reads fourth cipher-and-hashed data associated with an executable file of a second type and a first private key and fifth cipher-and-hashed data from the storage device; executes a second decryption-and-dehashing algorithm to decrypt and dehash the fourth cipher-and-hashed data by using the second log-in password to obtain a second private key; executes a second encryption-and-hashing algorithm to encrypt and hash the second log-in password by using the second private key to generate sixth cipher-and-hashed data; determines whether the fifth cipher-and-hashed data matches the sixth cipher-and-hashed data; and ends the whole process when the fifth cipher-and-hashed data does not match the sixth cipher-and-hashed data.

20. The apparatus of claim 19, wherein the processing unit allows execution of the executable file of the first type enclosed in the first cipher-and-hashed data and the executable file of the second type enclosed in the fourth cipher-and-hashed data when the fifth cipher-and-hashed data matches the sixth cipher-and-hashed data.
